(19) United States
(12) Patent Application Publication
(10) Pub. No.: US 2013/0215282 A1
(43) Pub. Date: Aug. 22, 2013

(54) EXAMINING APPARATUS AND METHOD FOR MACHINE VISION SYSTEM

(71) Applicant: M-VISION CO., LTD., (US)

(72) Inventor: Gu Youl Lee, Chungcheongbuk-do (KR)

(73) Assignee: M-VISION CO., LTD., Chungcheongbuk-do (KR)

(21) Appl. No.: 13/767,862

(22) Filed: Feb. 14, 2013

(30) Foreign Application Priority Data
Feb. 21, 2012 (KR) 10-2012-0017489

(51) Int. Cl. H04N 5/232

(52) U.S. Cl. CPC H04N 5/23216
USPC 348/207.11

(57) ABSTRACT

Provided is an examining apparatus for a machine vision system according to at least an exemplary embodiment of the present invention, the examining apparatus including: a supporter including one or more illuminations that illuminate an inner part thereof and having a predetermined shape; a portable terminal having a camera function and photographing an examination object positioned in the supporter while being fixed to the supporter; and a control unit setting a photographing condition of the portable terminal according to an instruction of the portable terminal and controlling the illuminations according to the set photographing condition.

### CROSS-REFERENCE TO RELATED APPLICATION

This application claims priority to and the benefit of Korean Patent Application No. 10-2012-0017489 filed in the Korean Intellectual Property Office on Feb. 21, 2012, the entire contents of which are incorporated herein by reference.

### TECHNICAL FIELD

The present invention relates to a machine vision system, and more particularly, to a machine vision system primarily used for an automated lot test in a production field.

### BACKGROUND ART

A machine vision system as a kind of factory automated system in which a camera and a computer substitute for a person who performs an operation with his/her eyes is a system in which the computer analyzes and processes video information acquired from the camera.

The machine vision system is primarily used for an automated lot test in a production field, and when the machine vision system is introduced for an automation test, the machine vision system is configured by varying specifications of an illumination, a camera, a lens, and the like according to an examination environment of the corresponding field.

However, in the related art, a machine vision system provider ('s employee) visits the field in person to check the condition and determines the specification through several tests in order to verify the examination environment and determine the specification of the system. Therefore, the machine vision system in the related art has a problem in that a lot of time and cost are required for the introduction.

In order to supplement the disadvantage, a smart camera which is an integrated machine vision system constituted by a camera, a lens, a cable, an embedded processor, and the like has been released and sold, but the smart camera also has a problem and in detail, since the smart camera itself is one type of the machine vision system, it is difficult for general persons who are short in knowledge of a machine vision to easily access the smart camera and since the smart camera is very expensive, the smart camera is not appropriate for a test in a field that intends to introduce the machine vision system. Accordingly, as problems occurring when introducing the machine vision system according to an existing method, since a consumer should directly compare and select a machine vision special provider that can provide an appropriate-performance system, a lot of time is required and since the consumer does not easily know price information or reliability for the machine vision system for each provider, the consumer generally selects the provider through personal connections or introduction, and as a result, it was impossible to solve a problem that it is difficult to effectively select an optimal machine vision provider.

### SUMMARY OF THE INVENTION

The present invention has been made in an effort to provide an examining apparatus for a machine vision system which a general person who is short in knowledge of a machine vision can also easily access and which can be rapidly and effectively constructed while minimizing a burden of expenses.

The present invention has also been made in an effort to provide an examining apparatus for a machine vision system which a general person who is short in knowledge of a machine vision can also easily access and which can be rapidly and effectively constructed while minimizing a burden of expenses and provide an examining method to rapidly and efficiently select an optimal provider among a plurality of machine vision system providers.

An exemplary embodiment of the present invention provides an examining apparatus for a machine vision system including: a supporter including one or more illuminations that illuminate an inner part thereof and having a predetermined shape; a portable terminal having a camera function and photographing an examination object positioned in the supporter while being fixed to the supporter; and a control unit setting a photographing condition of the portable terminal according to an instruction of the portable terminal and controlling the illuminations according to the set photographing condition.

The control unit may set the photographing condition according to a result of operating the portable terminal while the portable terminal fixed to the supporter is connected with the control unit.

The examining apparatus for a machine vision system may further include a database storing an image photographed by the portable terminal and the set photographing condition and allowing one or more providers' terminals to access the stored image and photographing condition. In this case, the database may automatically operate when the set photographing condition coincides with a predetermined photographing condition.

The portable terminal may be separable from the supporter.

The supporter may include a lens having a predetermined specification and the portable terminal may photograph the examination object under the set photographing condition through the lens.

The portable terminal may be a smart phone.

The photographing condition may include an illumination condition and a field of view (FOV).

Another exemplary embodiment of the present invention provides an examining method for a machine vision system, including: (a) setting a photographing condition of a portable terminal according to an instruction of the portable terminal having a camera function; (b) controlling one or more illuminations provided in a supporter to which the portable terminal is fixed to illuminate an inner part of the supporter according to the set photographing condition; (c) photographing, by the portable terminal, the examination object under illumination of the controlled illuminations; (d) storing the photographed image and the set photographing condition in a database; and (e) accessing, by one or more providers' terminals, the stored image and photographing condition and selecting a predetermined provider's terminal among the accessed providers' terminals.

In step (a), the photographing condition may be set according to a result of operating the portable terminal while the portable terminal fixed to the supporter is connected with the control unit.

The examining method utilizing a machine vision system using the portable terminal may further include determining whether the set photographing condition coincides with a predetermined photographing condition, after step (a) and before step (d); and performing step (d) when it is determined that the set photographing condition coincides with the predetermined photographing condition.

The portable terminal may be separable from the supporter.

The supporter may include a lens having a predetermined specification and the portable terminal may photograph the examination object under the set photographing condition through the lens.

The portable terminal may be a smart phone.

The photographing condition may include an illumination condition and a field of view (FOV).

Since an examining apparatus for a machine vision system according to at least an exemplary embodiment of the present invention is implemented by using a public portable terminal such as a smart phone, a general person who is short in knowledge of a machine vision can easily access the examining apparatus and the examining apparatus can be rapidly and effectively constructed while minimizing a burden of expenses. Herein, the case in which the examining apparatus can be rapidly constructed means that a machine vision system provider visits an examination field in person to take some samples of an examination object to a work site of the provider and thereafter, finds an optimal examination environment for examining the sample and manufactures a machine vision system suitable for the examination environment and provides the manufactured machine vision system to a consumer in the related art, while according to at least an exemplary embodiment of the present invention, a consumer who needs the machine vision system photographs an examination object through a portable terminal such as a smart phone possessed by the consumer himself/herself and the provider can rapidly start manufacturing the machine vision system without visiting the consumer in person.

According to at least an exemplary embodiment of the present invention, the consumer who needs the machine vision system can rapidly and efficiently select an optimal provider among a plurality of machine vision system providers. That is, in at least an exemplary embodiment of the present invention, data of a photographing condition (=examination environment) set by the present invention is stored and kept in a database and transmitted to an exclusive website to mediate between the consumer and the provider on-line, thereby saving a time and a cost required for the consumer to find the appropriate provider and the provider contacts various consumers on-line to make an infrastructure of improvement of sales. As a result, an on-line market in a machine vision field can be constructed by discarding an existing method in which dealing is achieved only off-line, thereby anticipating pioneering a new market of a new distribution structure which does not exist in an existing machine vision industrial field.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1A is a cross-sectional view of an examining apparatus according to an exemplary embodiment of the present invention.

FIG. 1B is a perspective view of the examining apparatus according to the exemplary embodiment of the present invention.

FIG. 1C is a side view of the examining apparatus according to the exemplary embodiment of the present invention.

FIGS. 2A and 2B are examples of the image photographed by the examining apparatus according to the exemplary embodiment of the present invention.

FIG. 3 is a flowchart illustrating an examining method according to an exemplary embodiment of the present invention.

FIG. 4 is a flowchart illustrating an examining method according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

In order to sufficiently understand the present invention, an operational advantage of the present invention, and an object achieved by exemplary embodiments of the present invention, the accompanying drawings illustrating the exemplary embodiments of the present invention and contents for describing the accompanying drawings should be referred to.

Hereinafter, an examining apparatus and an examining method for a machine vision system according to at least exemplary embodiments of the present invention will be described below with reference to the accompanying drawings.

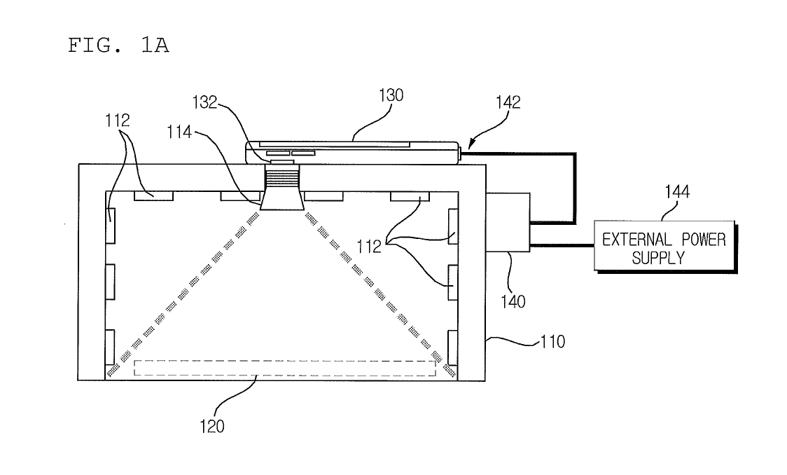

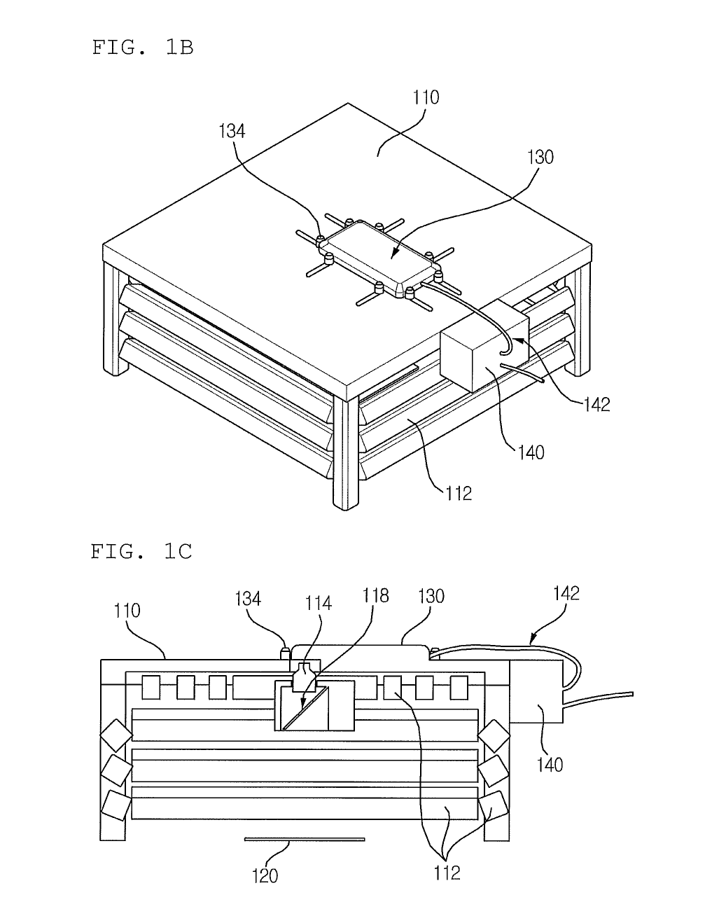

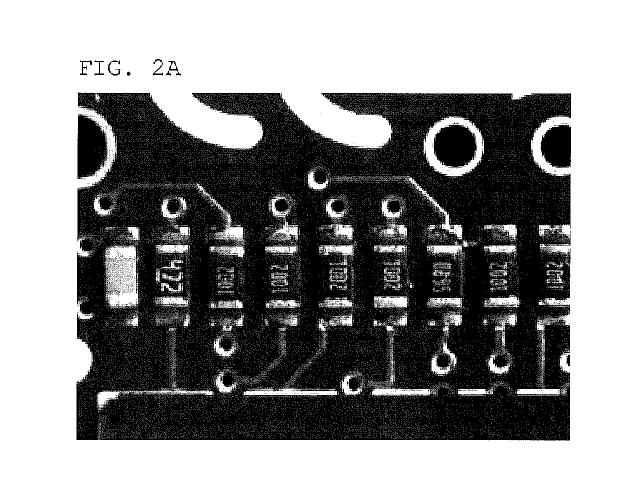

FIG. 1A is a cross-sectional view of an examining apparatus according to an exemplary embodiment of the present invention. FIG. 1B is a perspective view of the examining apparatus according to the exemplary embodiment of the present invention. FIG. 1C is a side view of the examining apparatus according to the exemplary embodiment of the present invention.

As illustrated in FIGS. 1A to 1C, an examining apparatus according to at least an exemplary embodiment of the present invention includes a supporter 110, a portable terminal 130, a control unit 140, and the like.

The supporter 110 includes one or more illuminations 112 that illuminate an inner part of the supporter 110. An LED illumination is one implementation example of the illumination 112. In this case, the LED illumination may be individual LEDs and may be various types such as a bar type, a ring type, a block type, and the like. The illumination 112 may be attached to the supporter 110, may be detached from the supporter 110, and may move up, down, left, right, or at 360°. The attachment and detachment may be variously applied, such as a socket type, and the like. Meanwhile, the LED illumination may be installed on all surfaces in the supporter 110, but not particularly limited thereto.

The supporter 110 may be made of a material having light shielding and blackout functions in order to prevent an illumination condition from being distorted due to external indirect light.

The supporter 110 has a predetermined shape, and may be a rectangular hexahedron formed in such a manner that an examination object 120 is positioned while opening the bottom of the supporter 110 as illustrated in FIGS. 1A to 1C and may be manufactured in various shapes as necessary, such as a triangular pyramid, a cylinder, a cone, and the like unlike the shape illustrated in FIGS. 1A to 1C.

The portable terminal 130 such as a smart phone is positioned on the top of the supporter 110, and a hole having a diameter which is equal to or larger than the size of a camera 132 is formed at a predetermined position (for example, the center) of the top of the supporter 110 and a lens (optical lens) having a predetermined specification is installed in the hole so as to verify the examination object 120 through the camera 132 of the portable terminal 130. In this case, the lens may be arbitrarily attached/detached regardless of a type thereof, and a magnification of the lens is adjustable.

A fixation bar 134 of which the size may be arbitrarily controlled according to the type of the portable terminal 130 is installed on the top of the supporter 110 to prevent the portable terminal 130 from swinging or moving when the portable terminal 130 photographs the examination object 120. The portable terminal 130 may be, of course, separated from the supporter 110.

The portable terminal 130 has a camera function. An implementation example of the portable terminal 130 may be various, but in this specification, it is assumed that the portable terminal 130 is a smart phone for easy description.

The portable terminal 130 photographs the examination object 120 positioned in the supporter 110 while being fixed to the supporter 110 by the fixation bar 134. An exclusive application may be installed in the portable terminal 130 so as for the portable terminal 130 to perform the photographing.

The control unit 140 sets a photographing condition of the portable terminal 130 according to an instruction of the portable terminal 130 and controls the illuminations 112 according to the set photographing condition. The photographing condition may include various numerical values associated with a photographing environment, and for example, the magnification of the lens 114, a condition of the illumination 112, a field of view (FOV), and the like may be included in the photographing condition. Herein, the illumination condition means on/off and brightness, an angle, and the like of the illumination 112. The control of the illumination 112 achieved by setting the illumination condition may be implemented up, down, left, and right, or at 360°.

The control unit 140 is connected with the portable terminal 130 through a data cable 142 to receive the instruction of the portable terminal 130. Herein, the instruction of the portable terminal 130 is generated as a user of the portable terminal 130 operates the portable terminal 130. The operation may be an operation of pressing a button or may be a touch operation like in the smart phone. An exclusive application may be installed in the portable terminal 130 so as for the portable terminal 130 to give the instruction. In this case, the exclusive application may be the same as the exclusive application installed in the portable terminal 130 so as for the portable terminal 130 to perform photographing.

The control unit 140 may be connected to an external power supply 144.

The user of the portable terminal 130, that is, a consumer who intends to purchase a machine vision system turns on a power supply of the illumination 112 and performs photographing by determining an optimal illumination condition according to the type of the examination object 120 with the exclusive application of the portable terminal 130 after making the positions of the portable terminal 130 and the optical lens 114 installed in the supporter 110 coincide with each other.

The examining apparatus according to at least one exemplary embodiment of the present invention further includes a database (not illustrated). In detail, the database is connected with at least one of the portable terminal 130 and the control unit 140 described above in a wired or wireless method. The database receives and stores an image photographed by the portable terminal 130 and the above set photographing condition from at least one of the portable terminal 130 and the control unit 140, and one or more providers' terminals may access the stored image and photographing condition. The providers' terminals mean terminals at machine vision system providers and a case in which the providers' terminals access the database on-line is one implementation example of the case in which the providers' terminals access the database. The database is a database of an exclusive website and the case in which the providers' terminals access the database means the case in which providers access the exclusive website. The providers' terminals may include a desktop PC, a notebook, a netbook, a tablet PC, a smart phone, and the like.

Meanwhile, the case in which the database receives the image photographed by the portable terminal 130 and the above set photographing condition from at least one of the portable terminal 130 and the control unit 140 may be an operation which is automatically started when the above set photographing condition coincides with a predetermined photographing condition.

The user who purchases the examining apparatus according to the present invention may receive an authentication of a product license and be granted an account in the exclusive website, and disclose an additional condition such as whether a special illumination is used, and like in addition to the photographing condition such as the lens magnification, the illumination condition, and the like by calling the data of the examination condition (=photographing condition) measured in the corresponding examining apparatus on the exclusive website. However, the image acquired by photographing the examination object 120 with the examining apparatus may be processed privately if the user does not want to make public due to security.

In the exclusive website, a list of products such as an existing lens, a charge coupled device (CCD) camera, an illumination, and the like which may constitute a machine vision system which is most suitable for the examination environment based on the data is filtered and shown to the user. When the user gives it public notice of a bid on the exclusive website in a form of a specification for requesting an estimate, various providers which may provide the machine vision system makes a bid to perform dealing.

The examining apparatus implemented according to at least one exemplary embodiment of the present invention is basically a small-sized desktop type, but the size or height may be increased or decreased as necessary.

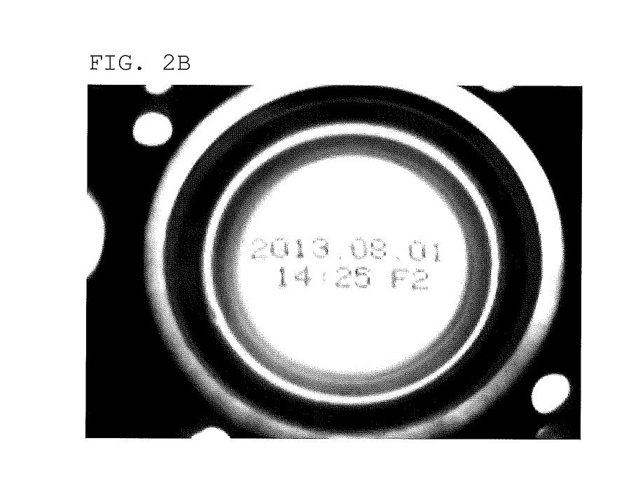

FIGS. 2A and 2B are examples of the image photographed by the examining apparatus according to the exemplary embodiment of the present invention. FIGS. 2A and 2B are the images acquired by photographing a PCB and the bottom of a can.

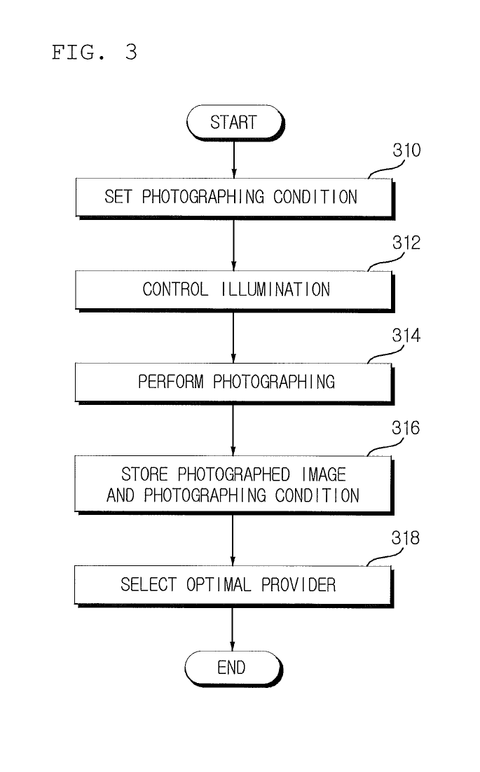

FIG. 3 is a flowchart illustrating an examining method according to an exemplary embodiment of the present invention.

FIG. 3 will be described below with reference to FIGS. 1A to 1C.

When the user operates the portable terminal 130 having the camera function, the portable terminal 130 instructs the operation result to the control unit 140 and the control unit 140 sets the photographing condition (for example, the illumination condition of the illumination 112, the FOV, and the like) of the portable terminal 130 according to the instruction (step 310).

After step 310, the control unit 140 is provided in the supporter 110 to which the portable terminal 130 is fixed to control one or more illuminations 112 that illuminate the inner part of the supporter 110 according to the set photographing condition (step 312).

After step 312, the portable terminal 130 photographs the examination object 120 under illumination of the illuminations controlled in step 312 (step 314).

After step 314, the database (not illustrated) stores the image photographed in step 314 and the photographing condition set in step 310 (step 316). The examining method according to the exemplary embodiment of the present invention further includes determining whether the set photographing condition coincides with a predetermined photographing condition after step 310 and before step 316; and performing step 316 when it is determined that the set photographing condition is the predetermined photographing condition.

After step 316, one or more providers' terminals access the stored image and photographing condition and the consumer who intends to purchase the machine vision system, that is, the terminal at the user side selects a predetermined provider's terminal among the accessed providers' terminals (step 318).

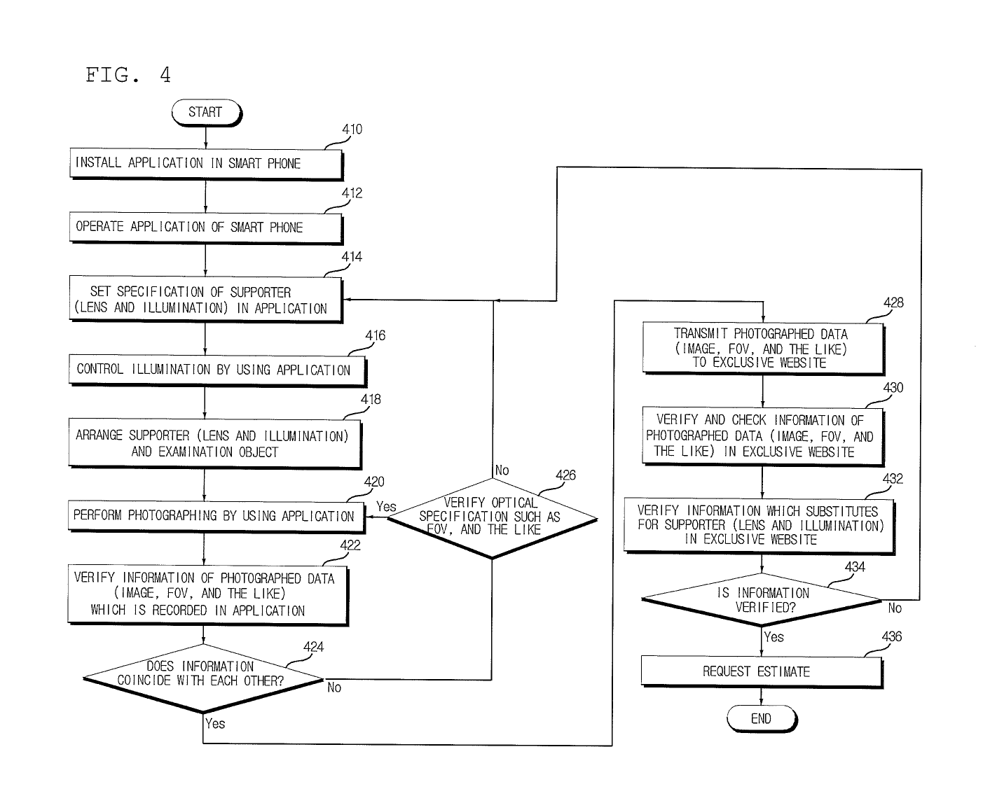

FIG. 4 is a flowchart illustrating an examining method according to an exemplary embodiment of the present invention.

FIG. 4 will be described below with reference to FIGS. 1A to 1C.

First, the user installs the exclusive application in the portable terminal 130 (step 410).

After step 410, the user executes the exclusive application of the portable terminal 130 (step 412).

After step 412, the user sets the photographing condition by operating the portable terminal 130 (step 414), and as a result, the control unit 140 sets the photographing condition (strictly, the case in which the control unit sets the photographing condition means that a content set in step 414 is electronically recognized) and controls the illuminations 112 according to the set photographing condition (step 416).

After step 416, the user positions the supporter 110 of the examining apparatus on the top of the examination object 120 in order to photograph the examination object 120, positions the portable terminal 130 on the top of the supporter 110 while making the camera 132 to be inclined downward, positions the lens 114 and the portable terminal 130 to coincide with each other, fixes the portable terminal 130 by using the fixation bar 134 installed to prevent the portable terminal 130 from moving or swinging during photographing, and connects the control unit 140 and the portable terminal 130 installed in the supporter 110 after fixation with each other by using a data cable 142 (step 418).

After step 418, the user photographs the examination object 120 by using the portable terminal 130 (step 420). In detail, the user turns on an illumination power supply in the supporter 110, optimizes the illumination condition, and photographs an optimal image of the examination object 120 by operating the exclusive application which is being executed.

After step 420, the user verifies information on the photographed image and the photographing condition (for example, the illumination condition, the FOV, and the lens magnification) recorded in the exclusive application of the portable terminal 130 (step 422).

In an examining method according to another exemplary embodiment of the present invention, it is determined whether the information verified in step 422 coincides with information which the user desires (step 424).

When it is determined that the information does not coincide with each other in step 424, in the examining method according to another exemplary embodiment of the present invention, it is again verified whether the optical specification such as the FOV, and the like is an optical specification which the user desires (step 426) and when the corresponding optical specification is the optical specification which the user desires, the process proceeds to step 420 and when it is determined that the corresponding optical specification is an optical specification which the user does not desire, the process proceeds to step 414.

When it is determined that the information coincides with each other in step 424, in the examining method according to another exemplary embodiment of the present invention, the photographed image and the photographing condition (illumination condition, W.D, lens magnification, and the like) are stored and transmitted to a separate (exclusive) database (step 428).

After step 428, the user verifies and checks the stored image and photographing condition on the exclusive website (step 430).

After step 430, when the user determines whether there is a condition to be added to (alternatively, to be substituted for) the stored photographing condition on the exclusive website, and when determining that there is the condition, the user verifies the information to be added or substituted (step 432).

After step 432, in the examining method according to another exemplary embodiment of the present invention, it is finally determined whether there is not information to be added or substituted any longer (step 434), and when it is determined that there is no information to be added or substituted any longer in step 434, the user performs an on-line bid to a plurality of machine vision system providers to select an optimal provider and request an estimate to the selected provider (step 436). In detail, the user pays a predetermined amount of brokerage to an operation company of the exclusive website, and makes public the stored image and photographing condition data in order to perform dealing with the machine vision system provider and makes a bid. The machine vision system provider verifies the corresponding dealing case and thereafter, makes a bid, and proposes a specification and a price of a system. The consumer performs dealing off-line by selecting an appropriate machine vision system provider. Meanwhile, when it is determined that there is the information to be added or substituted in step 434, the process proceeds to step 414.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An examining apparatus for a machine vision system, comprising:
a supporter including one or more illuminations that illuminate an inner part thereof and having a predetermined shape;
a portable terminal having a camera function and photographing an examination object positioned in the supporter while being fixed to the supporter; and
a control unit setting a photographing condition of the portable terminal according to an instruction of the portable terminal and controlling the illuminations according to the set photographing condition.

2. The examining apparatus for a machine vision system of claim 1, wherein the control unit sets the photographing condition according to a result of operating the portable terminal while the portable terminal fixed to the supporter is connected with the control unit.

3. The examining apparatus for a machine vision system of claim 1, further comprising:
a database storing an image photographed by the portable terminal and the set photographing condition and allowing one or more providers' terminals to access the stored image and photographing condition.

4. The examining apparatus for a machine vision system of claim 3, wherein the database automatically operates when the set photographing condition coincides with a predetermined photographing condition.

5. The examining apparatus for a machine vision system of claim 1, wherein the portable terminal is separable from the supporter.

6. The examining apparatus for a machine vision system of claim 1, wherein the supporter includes a lens having a predetermined specification and the portable terminal photographs the examination object under the set photographing condition through the lens.

7. The examining apparatus for a machine vision system of claim 1, wherein the portable terminal is a smart phone.

8. The examining apparatus for a machine vision system of claim 1, wherein the photographing condition includes an illumination condition and a field of view (FOV).

9. An examining method for a machine vision system using a portable terminal, comprising:
setting a photographing condition of a portable terminal according to an instruction of the portable terminal having a camera function;
controlling one or more illuminations provided in a supporter to which the portable terminal is fixed to illuminate an inner part of the supporter according to the set photographing condition;
photographing, by the portable terminal, the examination object under illumination of the controlled illuminations;
storing the photographed image and the set photographing condition in a database; and
accessing, by one or more providers' terminals, the stored image and photographing condition and selecting a predetermined provider's terminal among the accessed providers' terminals.

10. The examining method for a machine vision system of claim 9, wherein the setting, the photographing condition is set according to a result of operating the portable terminal while the portable terminal fixed to the supporter is connected with the control unit.

11. The examining method for a machine vision system of claim 9, further comprising:
determining whether the set photographing condition coincides with a predetermined photographing condition, after the setting and before the storing; and
performing the storing when it is determined that the set photographing condition coincides with the predetermined photographing condition.

12. The examining method for a machine vision system of claim 9, wherein the portable terminal is separable from the supporter.

13. The examining method for a machine vision system of claim 9, wherein the supporter includes a lens having a predetermined specification and the portable terminal photographs the examination object under the set photographing condition through the lens.

14. The examining method for a machine vision system of claim 9, wherein the portable terminal is a smart phone.

15. The examining method for a machine vision system of claim 9, wherein the photographing condition includes an illumination condition and a field of view (FOV).
